(19) United States
(12) Patent Application Publication
(10) Pub. No.: US 2009/0288689 A1
(43) Pub. Date: Nov. 26, 2009

(54) ULTRASONIC CLEANING SYSTEM FOR REMOVING HIGH DOSE ION IMPLANTED PHOTORESIST IN SUPERCRITICAL CARBON DIOXIDE

(75) Inventors: Kwon Taek Lim, Busan (KR); Min Young Lee, Busan (KR); Seung Ho Kim, Busan (KR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Pukyong National University Industry-University Cooperation Foundation, Busan (KR)

(21) Appl. No.: 12/467,532

(22) Filed: May 18, 2009

(30) Foreign Application Priority Data
May 26, 2008 (KR) 10-2008-0048349

(51) Int. Cl. B08B 3/12

(52) U.S. Cl. 134/184

(57) ABSTRACT

Disclosed is an ultrasonic cleaning system for removing a high dose ion-implanted photoresist in supercritical carbon dioxide. Specifically, the ultrasonic cleaning system includes one or more ultrasonic horns mounted inside a high pressure reactor to be operated in supercritical carbon dioxide and having a cross-section enabling uniform processing of an overall surface of a wafer, so that ultrasonic waves can be superposed in the high pressure reactor and uniformly distributed over the surface of a support provided as a cleaning target in a cleaning bath, thereby minimizing damage to a fine pattern on the surface of the support while effectively removing a high dose ion-implanted photoresist.

### CROSS-REFERENCE TO RELATED APPLICATION(S)

The present application claims priority to Korean Patent Application No. 10-2008-0048349, filed on May 26, 2008 in the Republic of Korea, and entitled “ULTRASONIC CLEANING SYSTEM FOR REMOVING HIGH DOSE ION IMPLANTED PHOTORESIST IN SUPERCRITICAL CARBON DIOXIDE”, the disclosure of which is incorporated by reference in its entirety.

### BACKGROUND OF THE INVENTION

1. Field of the Invention

The present invention relates to an ultrasonic cleaning system suitable for removing a high dose ion-implanted photoresist in supercritical carbon dioxide. More particularly, the present invention relates to an ultrasonic cleaning system which includes one or more ultrasonic horns mounted inside a high pressure reactor to be operated in supercritical carbon dioxide and having a cross-section enabling uniform processing of an overall surface of a wafer, so that ultrasonic waves can be superposed in the high pressure reactor and uniformly distributed over the surface of a support provided as a cleaning target in a cleaning bath, thereby minimizing damage to a fine pattern on the surface of the support while effectively removing a high dose ion-implanted photoresist.

2. Description of the Related Art

In a process of fabricating a semiconductor, cleaning is one of the most fundamental techniques. The process of fabricating the semiconductor includes many stages to process a wafer surface. In each stage, various contaminants are generated and remain on a semiconductor fabricating apparatus and a semiconductor wafer that has undergone a predetermined process. Therefore, it is necessary for the semiconductor fabricating apparatus and the semiconductor wafer to be cleaned at regular time intervals to carry out the subsequent processes.

With recent development of a high-density semiconductor device, a pattern to be formed on the wafer has become very small. Hence, the pattern on the wafer is liable to be affected even by a very fine particle, thereby causing a defective semiconductor device. As a result, emphasis is increasingly placed upon cleaning processes.

A photoresist made of various photosensitive polymers is used for forming a pattern image on a substrate, and is employed as a mask to screen an undesired area from ion implantation in an ion-implantation process for changing electrical characteristics of a device. During the ion implantation process, the surface of the photoresist is dehydrogenated and thus hardened to form a cross-linked and carbonized crust layer. Then, the carbonized layer protects the photoresist from a cleaning liquid and a solvent cannot invade this layer, so that a photoresist chip remains and cannot be easily removed by a current general wet or dry striping method.

A typical method of removing the photoresist having the carbonized layer includes a wet cleaning stage in which chemicals or dilute acids are used to remove residues remaining after oxygen plasma ashing. Here, plasma generation causes an increase in ambient temperature and the carbonized layer of the photoresist blocks a solvent or a low molecular weight volatile material from easily escaping from the photoresist, so that the photoresist is liable to swell or explode, thereby damaging a fine pattern. Further, exploded residue particles can be accumulated on the processing apparatus and adsorbed again by other substrates. To remove the residues, many cleaning processes are performed using a large amount of chemicals or dilute acid, but additional costs are required to remove the chemicals or dilute acid. Therefore, there is a need for an appropriate cleaning system.

The cleaning technique is used to remove various contaminants, produced during the semiconductor fabrication process, through physical and chemical methods.

First, the chemical method removes contaminants from the wafer surface through washing, etching, oxidation-reduction reaction, etc., and uses various chemicals or gases. In the chemical method, an attached particle is removed by a pure or chemical cleaning liquid, and an organic material is dissolved by a solvent, removed by oxidative acid, or carbonized in oxygen plasma. In some cases, the surface is etched to a certain extent to expose a new clean surface.

Next, the physical method uses ultrasonic energy to take off the adsorbed material, or employs a brush or high pressure water to remove the adsorbed material. In general, the physical method and the chemical method are combined for efficient cleaning.

That is, ultrasonic cleaning refers to a process for removing contaminants, attached to a cleaning target, through physical means (ultrasonic waves) and chemical means (chemical cleaning liquid), and for preventing the removed contaminants from reattachment. A physical phenomenon due to ultrasonic waves is accomplished by an ultrasonic cavitation phenomenon, which is a phenomenon wherein minute air bubbles are generated and eliminated by ultrasonic pressure when the ultrasonic waves propagate in liquid. Here, the cavitation phenomenon involves a very high pressure (air pressure from dozens to hundreds of atmospheres) and a very high temperature (hundreds to thousands of degrees).

This phenomenon alternates between creation and elimination within an extremely short time (from one-ten thousandth to one-hundred thousandth of a second). Thus, the cleaning target is cleaned in the liquid by shock waves at a deep inner part of the target out of sight within a short time.

In practice, agitation effect, heating action, etc. caused by radiation pressure of an ultrasonic wave itself are combined with the impact energy due to the cavitation to bring synergy with a cleaning agent, thereby providing a higher cleaning effect.

The ultrasonic cleaning is generally used in cleaning or rinsing the cleaning target, such as glass substrates for liquid crystal displays (LCDs), semiconductor wafers, and magnetic disks for data storage. In a typical ultrasonic cleaning system, a cleaning target is placed into a cleaning bath filled with cleaning water to which ultrasonic waves are applied from a vibrating plate activated by an ultrasonic vibrator. The ultrasonic waves vibrate particles on the cleaning target such that the particles and other contaminants can be effectively removed from the target.

However, since the intensity of the ultrasonic wave is widely varied due to an instant variation of cleaning conditions, such as operating frequency, requirement for cleaning water, power consumption, cooling conditions, and the like, during the cleaning process, there is a problem in that the surface of the semiconductor wafer is partially or wholly damaged during the process. Accordingly, there is an urgent need for an ultrasonic cleaning system which can reduce damage to the wafer.

Korean Patent Nos. 0597656 and 0559017 disclose methods of removing a general photoresist and a photoresist chip using supercritical carbon dioxide. However, it is difficult for these methods to remove the photoresist from a substrate having a carbonized surface hardened after high dose ion-implantation.

Korean Patent No. 0525855 discloses a technique for removing a high dose ion-implanted photoresist in supercritical carbon dioxide after oxygen plasma ashing. This technique removes the high dose ion-implanted photoresist residue using carbon dioxide after oxygen plasma ashing, but cannot completely remove the residue, thereby requiring a separate rinsing process using alcohol and water to remove the residue such as co-solvents, photoresist chips, etc. that remain on the wafer. Such a process has a problem caused by the oxygen plasma ashing and requires an additional rinsing process to remove the chips that are not removed by the carbon dioxide process, thereby lowering production efficiency and causing extra costs and other environmental problems.

Korean Patent No. 0469339 relates various surfactants for carbon dioxide, and discloses a method for removing contaminants using the same. However, such a cleaning agent (the surfactants, the co-solvents and the additives) not only has low solubility to carbon dioxide, but also takes a long processing time. Further, a residue may remain on a support.

As such, in the supercritical dry cleaning method, which has been hitherto employed to remove contaminants, a surfactant, a co-solvent, an additive, and the like are simply mixed in supercritical carbon dioxide. However, this method has disadvantages in that that it takes considerable time to completely dissolve and remove the contaminants using a supercritical carbon dioxide mixture of the co-solvent and the additive. Particularly, in the case of an insoluble contaminant such as a high dose ion-implanted photoresist, a chemical mechanism is insufficient to effectively remove the contaminant.

Further, although the method using ultrasonic waves has been proposed as a physical method, the intensity of the ultrasonic wave is widely varied by instant variation of cleaning conditions such as operating frequency, requirement for cleaning water, power consumption, cooling conditions, etc. in the cleaning process, thereby causing partial or whole damage to the surface of the semiconductor wafer.

### SUMMARY OF THE INVENTION

Therefore, the present invention is directed to solve the problems of the related art as described above, and an aspect of the present invention is to provide an ultrasonic cleaning system that is attached to an inside of a reactor to effectively remove a high dose ion-implanted photoresist in supercritical carbon dioxide and includes a plurality of horns.

In accordance with an aspect of the present invention, an ultrasonic cleaning system for cleaning a support in supercritical carbon dioxide include: a cover mountable in a carbon dioxide high pressure reactor cell; a plurality of vibration transfer members positioned at various locations inside the cover and transferring ultrasonic waves to a supercritical fluid and a cleaning liquid to vibrate the cleaning liquid; and a vibration generator oscillating the vibration transfer members.

In according with another aspect of the present invention, an ultrasonic system includes a plurality of horns in a high pressure reactor to remove a high dose ion-implanted photoresist in supercritical carbon dioxide.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is a plan view of an ultrasonic device according to an exemplary embodiment of the present invention;

FIGS. 2 and 3 are plan views of a system for removing contaminants through the ultrasonic device in supercritical carbon dioxide according to an exemplary embodiment of the present invention;

FIG. 4 is a plan view of an ultrasonic horn; and

FIG. 5 is a scanning electron microscope (SEM) photograph before striping, and

FIG. 6 is an SEM photograph showing that a high dose ion-implanted photoresist is removed under an optimum processing condition using the ultrasonic device.

### DETAILED DESCRIPTION OF THE EMBODIMENT

Embodiments of the present invention will be described with reference to the accompanying drawings.

The present invention is directed to provide an innovative ultrasonic module suitable for a cleaning process using supercritical carbon dioxide, which includes an ultrasonic device inside a high pressure reactor to reduce time for dissolving a cleaning agent in carbon dioxide and significantly increase solubility of a supercritical carbon dioxide mixture of a co-solvent and an additive to the high dose ion-implanted photoresist while providing strong physical vibration, thereby removing the high dose ion-implanted photoresist without leaving residues on the support. Further, the plurality of horns is mounted on the reactor such that ultrasonic waves can be superposed inside the high pressure reactor and uniformly distributed on the surface of the support provided as a cleaning target in a cleaning bath, thereby minimizing damage to the surface of the wafer.

Since supercritical carbon dioxide has high diffusivity and low surface tension, it can be rapidly infiltrated together with a co-solvent into a carbonized surface of the high dose ion-implanted photoresist, so that there is no explosion of the photoresist due to intense heat generated during plasma ashing. In the ultrasonic device, supercritical carbon dioxide used along with the co-solvent and the additive also serves to properly dissolve and remove a photoresist component from a substrate, so that the high dose ion-implanted photoresist can be rapidly removed from the substrate. Further, the plural horns allow the ultrasonic waves to be overlapped in the high pressure reactor and uniformly distributed on the surface of the support provided as the cleaning target in the cleaning bath, thereby minimizing damage to the surface of the wafer.

According to an embodiment of the present invention, an ultrasonic system includes a plurality of horns in a high pressure reactor to remove a high dose ion-implanted photoresist in supercritical carbon dioxide.

Since supercritical carbon dioxide diffuses rapidly like gas and has extremely low surface tension, it can be relatively easily infiltrated into a carbonized surface of the ion-implanted photoresist and can flow as a wet medium like a liquid.

However, non-polar supercritical carbon dioxide cannot effectively dissolve polar photoresist components even when a co-solvent and an additive are added thereto. Thus, it has been tried to mount an ultrasonic device inside the reactor to enhance removal efficiency.

On the other hand, when the ultrasonic system is placed in supercritical carbon dioxide, reaction between a high dose ion-implanted photoresist and a cleaning agent such as a surfactant and a co-solvent is facilitated by ultrasonic waves while applying physical vibration to the support, thereby enhance efficiency of removing the high dose ion-implanted photoresist from the support by increasing solubility thereof. Further, the plural horns allow the ultrasonic waves to be overlapped in the high pressure reactor while being uniformly distributed on the surface of the support provided as a cleaning target in a cleaning bath, thereby minimizing damage on the surface of the wafer.

As a non-polar solvent, supercritical carbon dioxide rapidly diffuses like gas and can be infiltrated into a fine pore. That is, supercritical carbon dioxide has a surface tension of approximately 0, so that it can be infiltrated into a fine pattern. However, since it is difficult to dissolve the high dose ion-implanted photoresist containing polar materials by only supercritical carbon dioxide, a cleaning agent (surfactants and co-solvents) containing components capable of dissolving the photoresist may be added. At this time, the ultrasonic waves are used to increase a dissolution rate of contaminants into the cleaning agent, and a physical force of strong ultrasonic waves is applied to the surface of the support, thereby reducing time for removing the contaminants from the support.

Further, the plurality of horns can minimize damage to the surface of the wafer.

According to the embodiment of the present invention, the ultrasonic system includes the plurality of horns in the high pressure reactor to remove the high dose ion-implanted photoresist in supercritical carbon dioxide.

To add ultrasonic waves to a mixing process, an ultrasonic wave generator including a plurality of horns is received in a supercritical carbon dioxide reactor.

The reactor is designed to freely have internal temperature and pressure in a range from 30-150° C. and 2000-5000 psi, respectively.

If the contaminants are removed by the aforementioned method, the additive is dissolved more quickly and the contaminants are removed more easily from the support than the method not employing ultrasonic waves, thereby reducing reaction time while enhancing cleaning effects.

Since strong ultrasonic waves are applied to supercritical carbon dioxide, the contaminants are not only easily dissolved in the mixture of the carbon dioxide, the surfactant and the co-solvent, but insoluble contaminants are completely separated from the surface of the support.

The supercritical fluid mixture may contain supercritical carbon dioxide, a surfactant for carbon dioxide, a co-solvent and an additive to remove and rinse the contaminants attached on the support.

The surfactant may be an amphoteric surfactant composed of a carbon dioxide-phobic (hydrophilic or lipophilic) part and a carbon dioxide-philic part. For example, the carbon dioxide-philic part may include one of perfluoropolyether and perfluorocarbon.

The co-solvent may include a polar solvent (N-methylpyrrolidone (NMP), dimethyl sulfoxide (DMSO), dimethylacetamide (DMAc), dimethylformamide (DMF), tetrahydrofuran (THF), and acetone), alcohol (isopropanol (IPA), ethanol, and propanol, diethylene glycol), or etc. For example, one or more co-solvents may be used.

The additive may include tetra-alkyl ammonium hydroxide, formalin, formic acid, acetic acid, amino acid, oxalic acid, etc. The present cleaning apparatus can effectively clean without these additives, but one or more additives may be used as necessary.

The higher the temperature, the more effective the supercritical fluid mixture is in cleaning. Thus, the temperature may be adjusted appropriately. Among the aforementioned various supercritical fluid mixtures, one or mixtures thereof may be used or they may be used in sequence according to the kinds of contaminants to be removed.

The ultrasonic horn has a predetermined-sized circular cross-section. Alternatively, the horn may be designed to have other cross-sections than the circular cross-section so long as it can mix supercritical carbon dioxide and a cleaning agent uniformly and does not damage a fine pattern. The ultrasonic waves may damage the wafer when it has a low frequency. Thus, an ultrasonic wave having a frequency in the range of 10-1000 kHz is used. One or more ultrasonic horns may be used, or the ultrasonic horn may be enlarged to generate an ultrasonic wave having a cross-section of 200 mm². Here, the horn may be made of quartz that effectively transfers ultrasonic energy, is unlikely to be heated and has no effect on the pattern. A horn made of quartz is generally used in the supercritical dry cleaning, but may be etched when used for the supercritical dry cleaning with fluoric acid. Therefore, the horn may be formed of sapphire, silicon carbide, boron nitride, carbon glass or combination thereof.

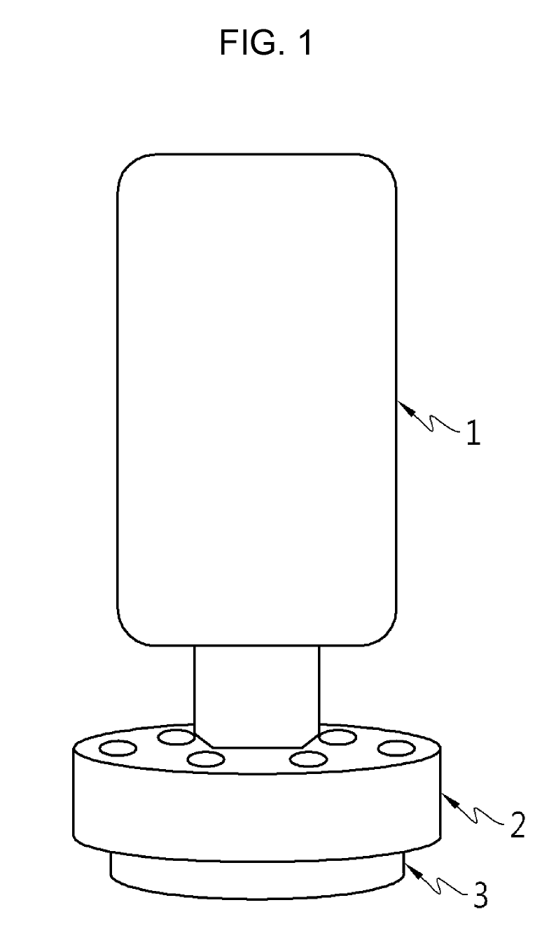

Referring to the drawings, an ultrasonic device 20 may be placed above or below a high pressure reactor 16. Referring to FIG. 1, energy is generated by an energy generator 1 such as a piezoelectric transducer and is then transferred into a high pressure reactor 16 via a horn 3. The energy transferred into the high pressure reactor 16 via the horn 3 allows carbon dioxide, a surfactant, and a co-solvent, which are provided into the high pressure reactor 16, to be mixed for a short time. The agitated supercritical fluid mixture removes contaminants from the surface of a support. At this time, the horn 3 is designed to have a cross-section similar to that of the support, so that the ultrasonic energy propagated via the horn 3 is provided to the entire surface of the support. Thus, the ultrasonic energy is applied to the entire surface of the support, so that a substantially effective cleaning area can be enlarged and the amount of ultrasonic waves per unit time becomes larger, thereby enhancing the effect of cleaning the support.

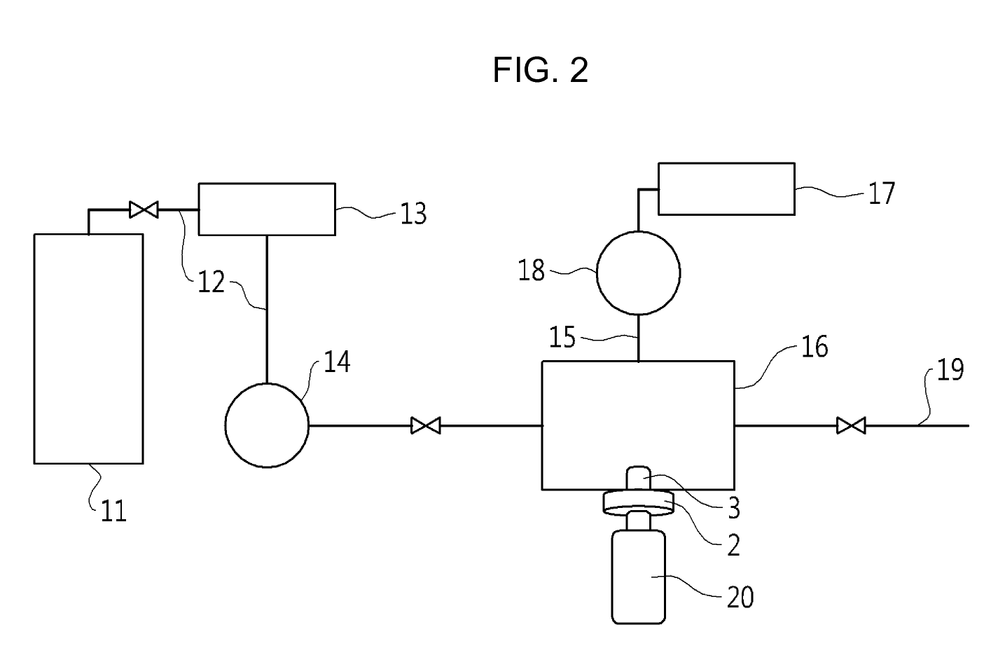

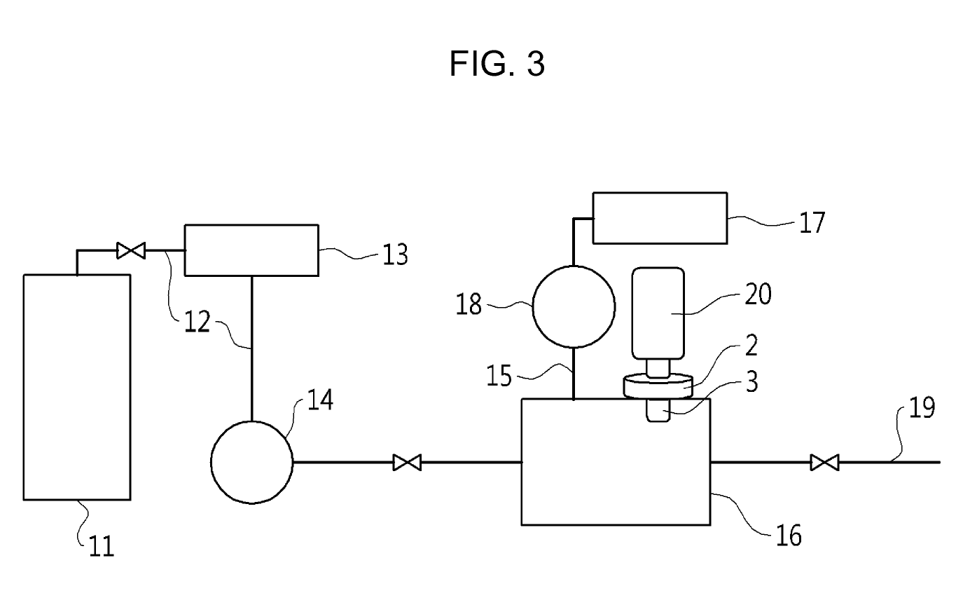

FIG. 2 and 3 shows a system for removing contaminants in supercritical carbon dioxide while using the ultrasonic device configured as described above. In the high pressure reactor 16, the support to which contaminants are attached is inserted along with the surfactant, the co-solvent and the additives. Then, the high pressure reactor 16 is closed by a cover 2 having the ultrasonic device 20.

Further, a heater 17 attached to the high pressure reactor 16 to adjust a reaction temperature, a circulating pump 18 for circulating a heated fluid around the reactor, and a circulation pipe 15 keep the internal temperature of the high pressure reactor 16 constant.

Then, a high pressure pump 14 for supplying carbon dioxide from a carbon dioxide source 11 in a high pressure state is used to supply carbon dioxide into the high pressure reactor 16 through a supply pipe 12, and the ultrasonic device 20 operates to make a supercritical fluid mixture and remove the contaminants.

When the contaminants are completely removed, the remaining supercritical fluid mixture is discharged through a vent line 20, and an upper part of the support is rinsed by pure supercritical carbon dioxide. Then, the support with no contaminant is obtained by discharging supercritical carbon dioxide.

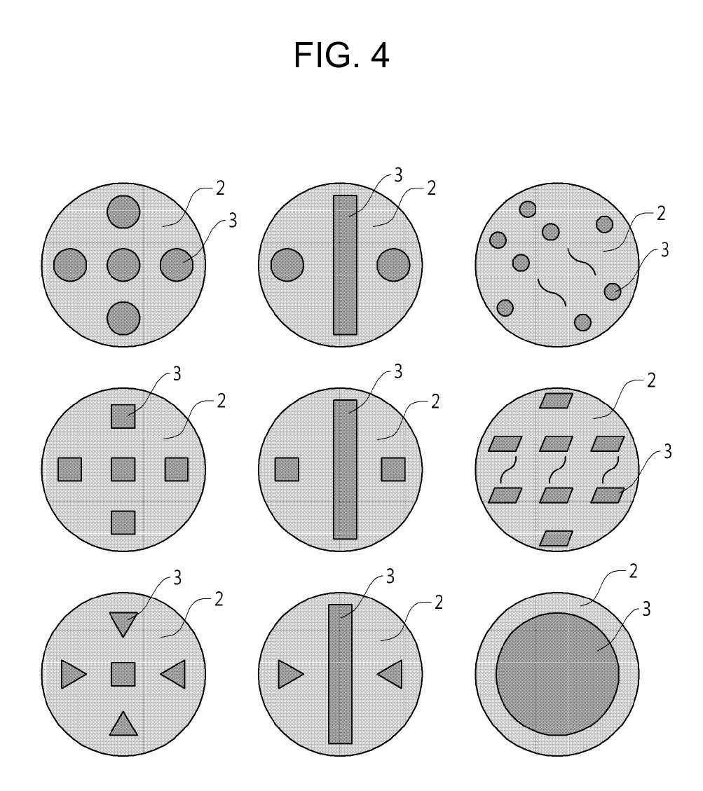

FIG. 4 is a plan view showing various examples of ultrasonic horn of the present invention. The horn is attached to a cover of a high pressure reactor. The horn includes the shape of circles, triangles or squares. The circles, triangles or squares are located longitudinally and transversely within the horn and spaced apart from each other.

The present invention will be described in more detail with reference to some examples.

### COMPARATIVE EXAMPLE 1

### Removal of High Dose Ion-Implanted Photoresist According to Pressure in Co-Solvent/Supercritical Carbon Dioxide without Ultrasonic Device

A wafer of 200 mm coated with a high dose ion-implanted photoresist was prepared, in which a photoresist surface was dehydrogenated and hardened to form a cross-linked and carbonized crust layer.

A single solvent such as alcohols (methanol, ethanol), acetone, tetrahydrofuran (THF), dimethyl sulfoxide (DMSO), N-methylpyrrolidone (NMP), etc. was employed as a co-solvent and added in a concentration of 10% to carbon dioxide. Experiments for removing the photoresist were carried out according to pressure at a reaction temperature of 40° C. for 5 minutes. Table 1 shows the results thereof.

### EXAMPLE 1

### Removal of High Dose Ion-Implanted Photoresist According to Pressures in Co-Solvent/Supercritical Carbon Dioxide with Ultrasonic Device

The same wafer as that of Comparative Example 1 was used and a single solvent such as alcohols (methanol, ethanol), acetone, tetrahydrofuran (THF), dimethyl sulfoxide (DMSO), N-methylpyrrolidone (NMP), etc. was employed as a co-solvent and added in a concentration of 10% to carbon dioxide. The experiments of removing the photoresist were carried out using the ultrasonic device according to pressures at a reaction temperature of 40° C. for 2 minutes. Table 1 shows the results thereof.

TABLE 1
Removal of photoresist according to pressure

| | Stripping effect (%) | |
|---|---|---|
| Pressure (psi) | Without ultrasonic device | With ultrasonic device |
| 2500 | 25 | 30 |
| 3000 | 30 | 30 |
| 3500 | 30 | 40 |
| 4000 | 40 | 50 |

### COMPARATIVE EXAMPLE 2

### Removal of High Dose Ion-Implanted Photoresist According to Temperature in Co-Solvent/Supercritical Carbon Dioxide without Ultrasonic Device

The same wafer as that of Comparative Example 1 was used and a single solvent such as acetone and dimethyl sulfoxide (DMSO) was employed as a co-solvent and added in a concentration of 10% to carbon dioxide. The experiments of removing the photoresist were carried out while changing the reaction temperature at a reaction pressure of 4000 psi for 5 minutes. Table 2 shows the results thereof.

### EXAMPLE 2

### Removal of High Dose Ion-Implanted Photoresist According to Temperatures in Co-Solvent/Supercritical Carbon Dioxide with Ultrasonic Device

The same wafer as that of Comparative Example 1 was used, and a single solvent such as acetone and dimethyl sulfoxide (DMSO) was employed as a co-solvent and added in a concentration of 10% to carbon dioxide. The experiments of removing the photoresist were carried out using the ultrasonic device while changing the reaction temperature at a reaction pressure of 4000 psi for 2 minutes. Table 2 shows the results thereof.

TABLE 2
Removal of photoresist according to temperature

| | Stripping effect (%) | |
|---|---|---|
| Temperature (° C.) | Without ultrasonic device | With ultrasonic device |
| 40 | 30 | 40 |
| 50 | 30~40 | 60 |
| 60 | 40 | 70 |
| 70 | 50 | 80 |

### COMPARATIVE EXAMPLE 3

### Removal of High Dose Ion-Implanted Photoresist According to Time in Optimum Processing Conditions (Co-Solvent/Pressure/Temperature/Concentration) without Ultrasonic Device

The same wafer as that of Comparative Example 1 was used, and dimethyl sulfoxide (DMSO) was employed as a co-solvent and added in a concentration of 10% to carbon dioxide. The experiments of removing the photoresist were carried out while changing time at a reaction pressure of 4000 psi and a reaction temperature of 70° C. Table 3 shows the results thereof.

### EXAMPLE 3

### Removal of High Dose Ion-Implanted Photoresist According to Time in Optimum Processing Conditions with Ultrasonic Device

The same wafer as that of Comparative Example 1 was used, and dimethyl sulfoxide (DMSO) was employed as a co-solvent and added in a concentration of 10% to carbon dioxide. The experiments of removing the photoresist were carried out using the ultrasonic device while changing time at a reaction pressure of 4000 psi and a reaction temperature of 70° C. Table 3 shows the results thereof.

TABLE 3
Removal of photoresist according to time
Stripping effect (%)

| Time (second) | Without ultrasonic device | With ultrasonic device |
|---|---|---|
| 120 | — | 80 |
| 150 | — | 80 |
| 180 | — | 100 |
| 210 | — | 100 |
| 300 | 50 | — |
| 600 | 50 | — |

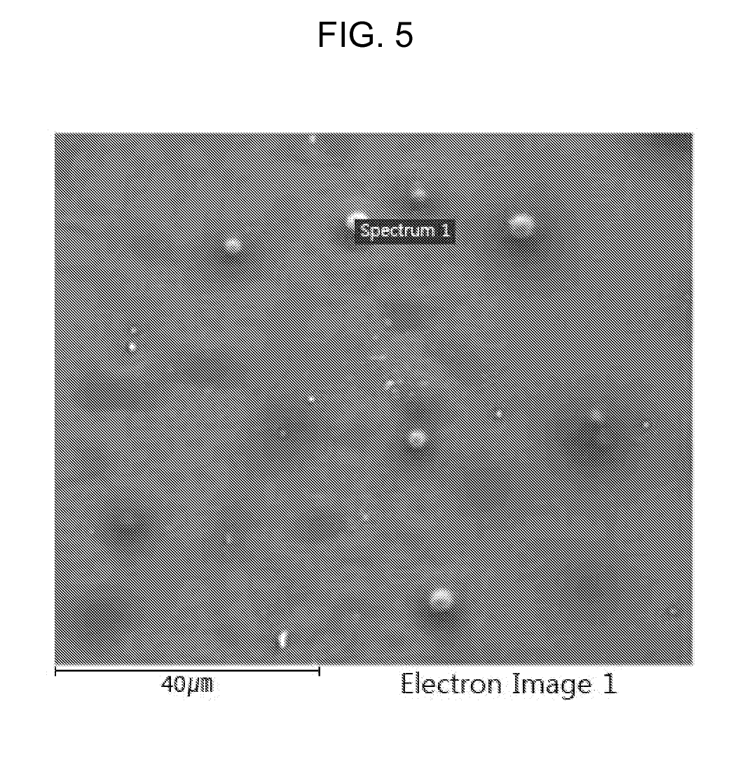

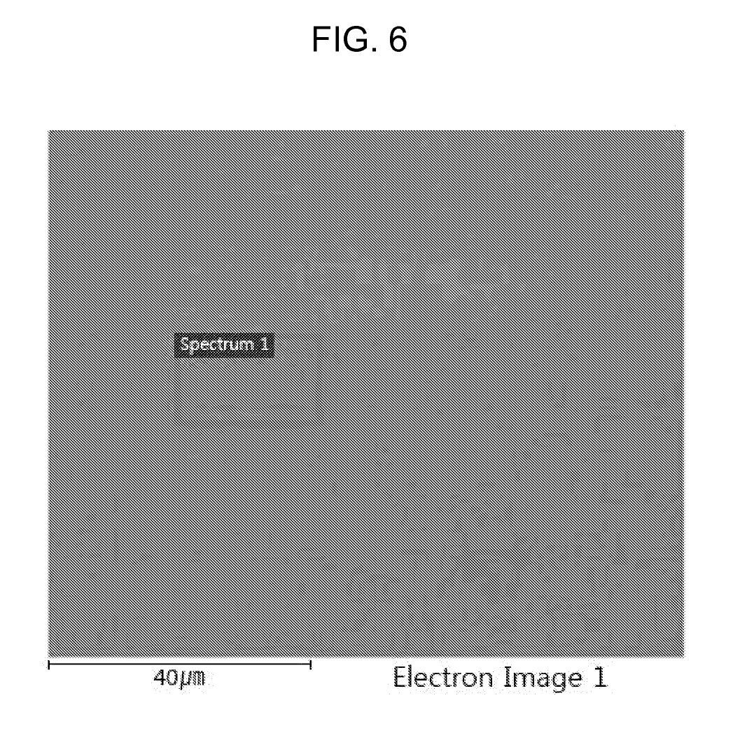

Further, FIG. 6 is a scanning electron microscope (SEM) photograph after the process under the conditions that the ultrasonic device were used; the single solvent such as dimethyl sulfoxide (DMSO) was employed as the co-solvent and added in a concentration of 10% to carbon dioxide; and a reaction pressure, a reaction temperature and a processing time were 4000 psi, 70° C. and 3 minutes, respectively. As compared with FIG. 5 that shows a SEM photograph before the process, it can be seen from FIG. 6 shows that contaminants were completely removed from a support. Also, energy dispersive x-ray microanalysis (EDX) data shows that C: 77.85%, O: 8.64% and Si: 13.52% before the process was changed into Si: 100% after the process. Thus, it can be seen that an organic material was removed by 100%.

As apparent from the above description, the ultrasonic system can completely remove the contaminants from the surface of the support without damage to a pattern by rapidly dissolving contaminants using a mixture of supercritical carbon dioxide, surfactants, co-solvents and additives, thereby reducing cleaning time while improving cleaning performance as compared with conventional methods.

Although some embodiments have been provided to illustrate the present invention, it will be apparent to those skilled in the art that the embodiments are given by way of illustration, and that various modifications and equivalent embodiments can be made without departing from the spirit and scope of the present invention. Accordingly, the scope of the present invention should be limited only by the accompanying claims and equivalents thereof.

1. An ultrasonic cleaning system for cleaning a support in supercritical carbon dioxide, comprising:
a cover mountable in a carbon dioxide high pressure reactor cell;
a plurality of vibration transfer members positioned at various locations inside the cover and transferring ultrasonic waves to a supercritical fluid and a cleaning liquid to vibrate the cleaning liquid; and
a vibration generator oscillating the vibration transfer members.

2. The ultrasonic cleaning system according to claim 1, wherein the vibration transfer member comprises one selected from the group consisting of quartz, sapphire, silicon carbide, boron nitride, carbon glass, and a combination thereof.

3. The ultrasonic cleaning system according to claim 2, wherein at least one vibration transfer member is provided to the system to uniformly transfer the ultrasonic waves to an overall surface of the support without being concentrated when loaded on the support.

4. The ultrasonic cleaning system according to claim 3, wherein the vibration transfer members are spaced from each other in transverse and longitudinal directions to uniformly transfer the ultrasonic waves to an overall surface of the support without being concentrated.

5. The ultrasonic cleaning system according to claim 3, wherein the vibration transfer members are arranged to constitute a multiple alignment and are spaced from each other in transverse and longitudinal directions to uniformly transfer the ultrasonic waves to an overall surface of the support without being concentrated.

6. The ultrasonic cleaning system according to claim 1, wherein the ultrasonic wave has a frequency in the range of 10-1000 kHz.

7. The ultrasonic cleaning system according to claim 1, wherein the cleaning liquid comprises a surfactant, a co-solvent, and an additive.

8. The ultrasonic cleaning system according to claim 7, wherein the surfactant comprises an amphoteric surfactant composed of a carbon dioxide-phobic part and a carbon dioxide-philic part, the carbon dioxide-philic part comprising one of perfluoropolyether and perfluorocarbon, and the cleaning liquid comprises at least one surfactant.

9. The ultrasonic cleaning system according to claim 7, wherein the co-solvent comprises a polar solvent selected from the group consisting of N-methylpyrrolidone, dimethyl sulfoxide, dimethylacetamide, dimethylformamide, tetrahydrofuran, and acetone, or alcohols including isopropanol, ethanol, propanol and diethylene glycol, and the cleaning liquid comprises at least one co-solvent.

10. The ultrasonic cleaning system according to claim 7, wherein the additive is selected from the group consisting of tetra-alkyl ammonium hydroxide, formalin, formic acid, acetic acid, amino acid and oxalic acid, and the cleaning liquid comprises no additive or at least one additive.
